(19) United States
(12) Patent Application Publication
(10) Pub. No.: US 2005/0177494 A1
(43) Pub. Date: Aug. 11, 2005

(54) Method and system for processing electronic financial transactions

(76) Inventors: Dogulas F. Kelly, Jamesport, NY (US); Wayne Martin, Coral Springs, FL (US)

Correspondence Address: Mark J. Schidkraut;Kaye Scholer LLP, 425 Park Avenue, New York, NY, 10022-3598, US

(21) Appl. No.: 10/776,302

(22) Filed: Feb. 11, 2004

(51) Int. Cl. G06F 17/60

(52) U.S. Cl. 705/39

(57) ABSTRACT

A system and method is provided that enables the processing of electronic payment transactions. The system and method includes a data transaction provider which is configured for receiving a request to process electronic payment transactions, funding the transactions and generating reports respecting such transactions. In accordance with an embodiment of the invention, payment to a merchant is effectuated by funding transactions that transpired during a predetermined period, regardless of whether confirmation that the funds have been transferred by the consumer is received.

### FIELD OF THE INVENTION

The invention relates to systems and methods for processing financial transactions, and more particularly to a system and method for processing electronic payment transactions.

### BACKGROUND OF THE INVENTION

Merchants typically accept various forms of payments from consumers in the course of engaging in the sale of goods and/or services. Some of these transactions include payments by cash, by check, debit card, credit card and the like.

Many of these forms of payments are electronic in nature (e.g., credit card, debit card, electronic check payments, stored value cards, loyalty points redemptions, electronic benefits transfers) and afford certain conveniences to consumers. For example, when electronic payments are accepted, consumers do not have to determine whether they have a sufficient amount of cash on their person, they often do not have to transfer funds to the merchant immediately, and at times, can purchase goods or services utilizing a line of credit.

Although such electronic payments are convenient to consumers, certain inconveniences are recognized by merchants involved in such transactions. For example, when the electronic system that supports an electronic form of payment fails, the merchant must contact the entity that processes the electronic payment. On other occasions, the merchant may have to call one of these entities if there is a problem with the form of payment that is presented (e.g., the consumer's credit card or debit card is not authorized for some reason unknown to the merchant and consumer).

Because the processing of electronic transactions frequently requires communication between the merchant and a data transaction provider (i.e., the institution or system that processes the electronic payment), it becomes even more inconvenient to the merchant when multiple data processing providers are used to support the merchant's electronic payment transaction needs.

In some circumstances, a merchant's credit card transactions are processed by one data transaction provider, the merchant's debit card transactions are processed by another provider and other electronic payment methods accepted by the merchant are handled by yet another data transaction provider or set of providers. In such circumstances, the merchant must identify the appropriate provider to contact when communication with a data transaction provider is required.

Moreover, after an electronic payment is made, merchants typically await the receipt of payment and reports (e.g., statements) from the data transaction providers that process the merchant's transmissions. During this settlement and reporting stage of electronic payment transactions, the merchant tends to recognize additional inconveniences arising from the receipt of multiple payments and reports due to the merchant's activity with multiple data transaction providers.

### SUMMARY OF THE INVENTION

Accordingly, a need has arisen in which data transaction providers can offer consumers convenience by the merchants' acceptance of various forms of electronic payments, while minimizing inconveniences recognized by such merchants arising from their interaction with multiple data transaction providers.

A system and method is provided that enables the processing of a plurality of electronic payment transaction types by a system or group of systems that are in communication with one another. These payment types include conventional debit card transactions, credit card transactions, electronic checking transactions, stored value card payments, loyalty points redemptions, and electronic benefits transfers.

In accordance with an embodiment of the invention, the system and method includes a data transaction provider which is configured for receiving information relating to a plurality of electronic payment transactions, determining the type of electronic payment transactions that were processed, funding the transactions and generating reports respecting such transactions.

### BRIEF DESCRIPTION OF THE DRAWINGS

Further objects, features and advantages of the invention will become apparent from the following detailed description taken in conjunction with the accompanying drawings showing illustrative embodiments of the invention, in which:

FIG. 1 is a block diagram of a system that incorporates features of the present invention for processing electronic payment transactions;

FIG. 2 is a block diagram of data storage devices and components of servers used in the system of FIG. 1;

FIG. 3 is a flowchart illustrating the method of processing an electronic payment transaction in accordance with one embodiment of the invention; and

FIG. 4 is a flowchart illustrating the method of settling and reporting electronic payment transactions in accordance with one embodiment of the invention.

### DETAILED DESCRIPTION

The invention is directed to a method and system for processing financial transactions, and more particularly to a system and method for processing electronic payments, such as credit card, debit card and electronic check payments, stored value cards (e.g., gift cards, employee cards, pre-paid cards, merchandise return cards and electronic gift certificates), loyalty points redemptions (e.g., frequent flier mile programs), electronic benefits transfers (i.e., transfer of government benefits to a retailer account to pay for products received), and the like. Credit card, debit card and electronic checking payments are the electronic transactions that will be discussed herein, although it is understood that the other previously mentioned transaction types are also within the scope of the present invention.

It should be noted at this point that an “electronic check payment,” in accordance with an embodiment of the invention, is a check payment made by a consumer to a merchant for goods or services wherein the check is approved electronically by a third party and presented to the merchant as an authorization for the withdrawal of funds from an account associated with the consumer's check. In some instances, as a prerequisite to processing the electronic payment transaction, the check is signed and voided by the consumer. In an alternate embodiment, an electronic check payment may be any payment or refund which is executed by the provision of a check for a commercial transaction and where the check is electronically authorized at a point of sale and data provided therefrom is read for funding.

As described below, by configuring a system to handle each of these credit card, debit card and electronic check transactions, many, and in some cases all, of a merchant's electronic payment needs can be satisfied by the same processing system, or group of systems that are in communication with one another.

Such an arrangement may be beneficial to both the merchant and the data transaction provider. For example, a merchant can contact the same data transaction provider for the execution of its credit card, debit card and electronic checking transaction (collectively “electronic payment transactions”) needs. Likewise, funding may be paid and statements reported to the merchant by as few as one source, rather than a larger number of sources. As a result, time and money associated with the execution and maintenance of electronic payment transactions may be reduced.

In addition, by streamlining activity respecting the settling and reporting of merchants' electronic payment needs, the institution that handles the processing of such payments also recognizes certain benefits. For instance, by generating fewer statements per merchant per period (e.g., weekly, monthly, quarterly, etc.) while supporting an increased number of services (credit card, debit card and electronic check transactions), the amount of documentation—hard copy or electronic—required to process such transactions may be effectively managed. In addition, the opportunity to provide merchants with access to a system, or interrelated systems, that can handle an array of electronic payment transactions creates an opportunity for data transaction providers to increase their revenues.

The System

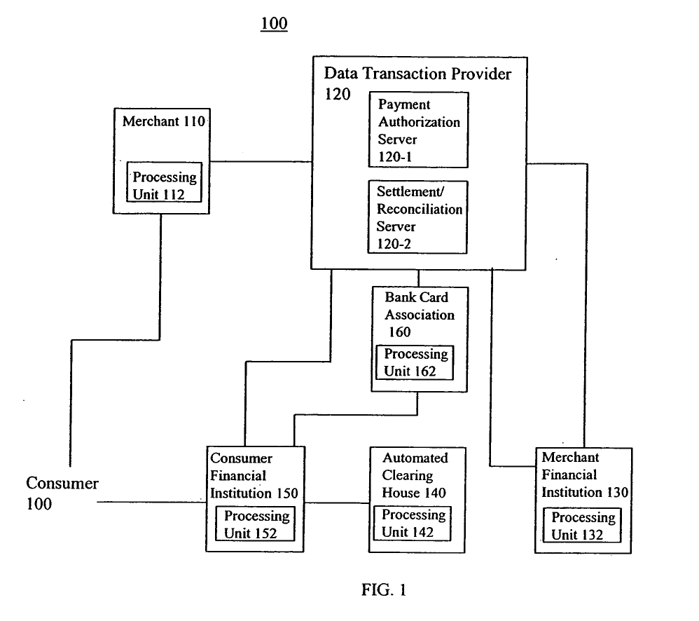

FIG. 1 is a block diagram illustrating an electronic payment system 100 that incorporates features of the present invention. System 100 handles the authorization, settling and reporting of electronic payment transactions. As shown in system 100, various parties are involved in the initiation and execution of such electronic payment transactions—namely, consumer 100, merchant 110, data transaction provider 120, merchant financial institution 130, automated clearing house 140, consumer financial institution 150 and bank card association 160. (The function of each of these parties and their interaction are described below.)

FIG. 1 includes data transaction processor 120 which, among other things, serves as a liaison between merchant 110, data transaction provider 120, merchant financial institution 130, automated clearing house 140, consumer financial institution 150 and bank card association 160 for processing electronic payment transactions as described herein. As shown in FIG. 1, data transaction provider 120 preferably includes two servers—payment authorization server 120-1 and settlement/reconciliation server 120-2—which, at various times, are in communication with one another and with one or more of merchant 110, merchant financial institution 130, automated clearing house 140, consumer financial institution 150 and bank card association 160 via their respective processing units 112, 132, 142, 152 and 162.

Although system 100 illustrates data transaction provider 120 comprising two servers 120-1, 120-2, the functionality of data transaction provider 120 described herein may be performed by any number of servers, including a single server, the two servers shown, or more than two servers. In addition, processing units 112, 132, 142 and 152 may be a mainframe, server, computer or some other device having computing capability and configured for communicating with data transaction provider 120 as well as other parties as described herein.

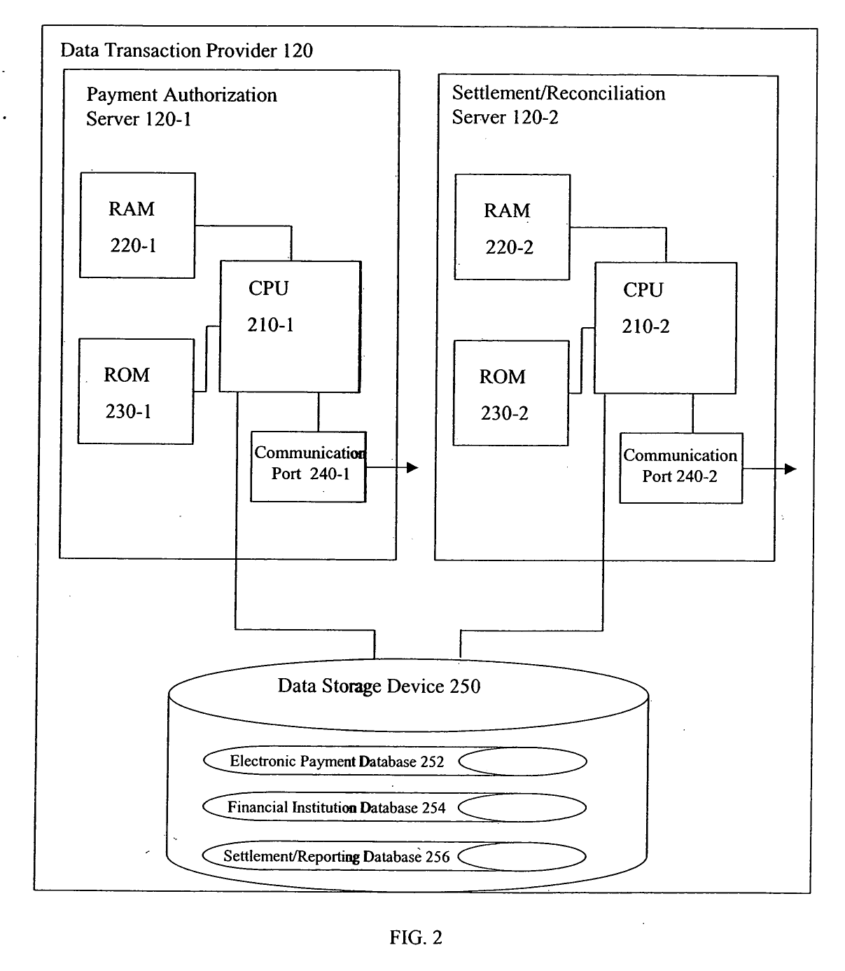

FIG. 2 is a block diagram showing the architecture of servers 120-1 and 120-2 used by system 100. Payment authorization server 120-1 preferably includes standard hardware components, such as central processing unit (CPU) 210-1, a random access memory (RAM) 220-1, a read only memory 230-1 and communications port 240-1. CPU 210-1 is preferably linked to each of the other listed elements, either by means of a shared data bus, or dedicated connections, as shown in FIG. 2.

CPU 210-1 may be embodied as a single commercially available processor. Alternatively, in another embodiment, the CPU 210-1 may be embodied as a number of such processors operating in parallel.

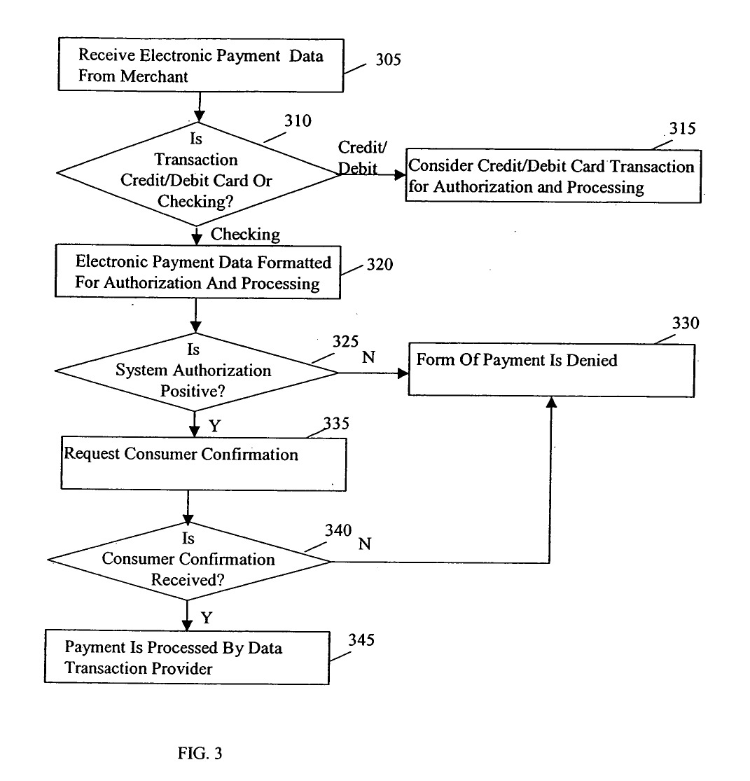

ROM 230-1 is operable to store one or more instructions, discussed further below in conjunction with FIG. 3, which the CPU 210-1 is operable to retrieve, interpret and execute. For example, ROM 230-1 preferably stores processes for receiving requests to process electronic payment transactions, determining the type of electronic payment transactions that are requested and qualifying (i.e., authorizing or rejecting) the electronic payment transactions as described below.

CPU 210-1 preferably includes a control unit, an arithmetic logic unit (ALU), and a CPU local memory storage device, such as, for example, a stackable cache or a plurality of registers, in a known manner. The control unit is operable to retrieve instructions from ROM 230-1. The ALU is operable to perform a plurality of operations needed to carry out instructions. The CPU local memory storage device is operable to provide high-speed storage used for storing temporary results and control information.

Communication port 240-1 connects payment authorization server 120-1 to settlement/reconciliation server 120-2. Communication port 240-1 further connects server 120-1 to merchant 110, merchant financial institution 130, consumer financial institution 150 and bank card association 160 by means of, for example, a TCP/IP connection using a wide area network.

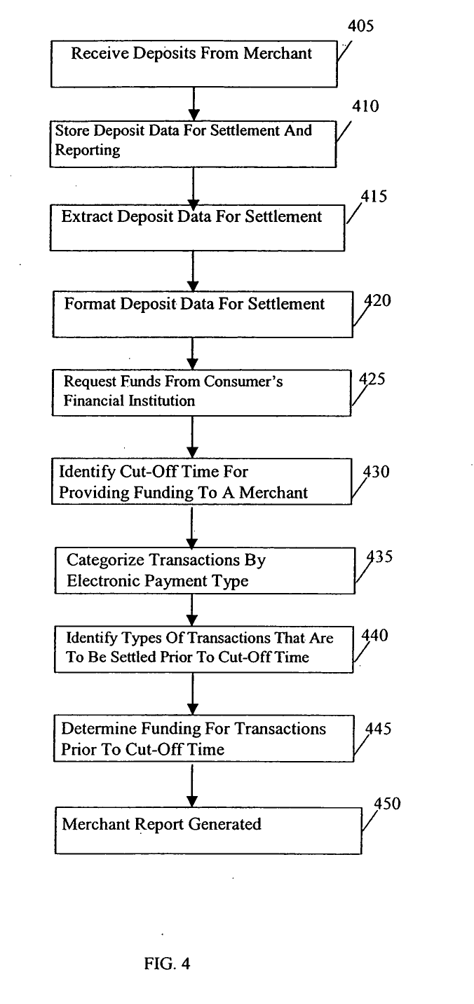

In accordance with an embodiment of the invention, settlement/reconciliation server 120-2 comprises the same type of components as payment authorization server 120-1. Thus, CPU 210-2, RAM 220-2, ROM 230-2 and communications port 240-2 are configured similar to components 210-1, 220-1, 230-1 and 240-1, respectively, as described above. ROM 230-2, however, preferably stores processes to receive sale deposit data from merchants, settle electronic payment transactions (including funding of) electronic payment transactions and report such transactions to merchants as described below with reference to FIG. 4.

Servers 120-1 and 120-2 are in communication with data storage device 250. Data storage device 250 contains one or more databases including, in one embodiment of the invention, electronic payment database 252, financial institution database 254, and settlement/reporting database 256. Electronic payment database 252 preferably stores information relating to the data generated at a point of sale and includes data relating to one or more of the following: the method of payment presented to merchant 110 (e.g., credit card, debit card, electronic check), consumer account information (e.g., account number, consumer financial institution information), merchant identification information (e.g., merchant name, merchant ID and merchant contact information), consumer identification information (e.g., consumer name), date of the transaction, time of the transaction and transaction amount (i.e., purchase price or refund amount).

Financial institution database 254 stores information relating to the financial institutions that interact with data transaction provider 120—such as, merchant financial institution 130, automated clearing house 140, consumer financial institution 150 and/or bank card association 160—and includes the name of the institution, institution contact information and institution identification codes (bank codes, routing codes, etc.).

Settlement/reporting database 256 preferably stores information relating to merchant requirements for settling electronic payment transactions and to the formatting and generation of merchant reports respecting electronic payment transactions during a predetermined period. Such information includes settlement frequency for each merchant, merchant interchange rate category, reporting frequency and reporting formats (e.g., electronic, hard copy).

As discussed more fully below, data transaction provider 120 is configured for, among other things, receiving a request to process electronic payment transactions, determining the type of electronic payment transactions that are requested, authorizing or rejecting the electronic payment transactions, funding and settling the transactions and generating reports respecting such transactions. Data transaction provider 120 is configured to process conventional credit card and debit card transactions. In addition, data transaction provider 120 is also configured to process electronic checking payment transactions in accordance with an embodiment of the invention. The processing, settling and reporting of such transactions is performed by a system or group of systems that are in communication with one another, thereby, in accordance with an embodiment of the invention, enabling a single point of contact between a merchant and the data transaction provider of such transactions. In addition, such a system supports a payment to merchants to effectuate funding of the electronic payment transactions that transpired during a predetermined period and providing a report to each merchant to document such transactions.

Processing Electronic Payment Transactions

FIG. 3 is a flowchart which illustrates a method, in accordance with an embodiment of the invention, for qualifying electronic payment transactions, including credit card, debit card and electronic checking payments.

Typically, a purchase is initiated when consumer 100 makes a request to purchase goods and/or service from merchant 110. If consumer 100 pays for the goods or service using cash or some other form of non-electronic payment, the data respecting the transaction is not processed via data transaction provider 120.

If, however, an electronic form of payment is offered by consumer 100, then certain data respecting the transaction (herein referred to as “electronic payment data”) is communicated by merchant 110 to payment authorization server 120-1 of data transaction provider 120 for storage by electronic payment database 252 of data storage device 250. In accordance with an embodiment of the invention, such data includes, the method of payment, consumer account information, merchant identification information, consumer identification information, date of the transaction, time of the transaction and transaction amount.

Some or all of this information may be inputted by merchant 110 manually (such as the purchase price or refund amount) or such information may be read electronically from, for example, the consumer's credit card, debit card or check. Consumer credit card or debit card information may be electronically read from a consumer's credit or debit card by swiping the card through a reader configured for reading information from the magnetic strip on the card. Consumer checking account information may be electronically read from a consumer's check by, for example, inserting the check in a magnetic ink character recognition (MICR) reader.

Merchant 110 inputs pertinent electronic payment data into merchant processing unit 112 for transmission to data transaction provider 120. Referring to FIG. 3, at step 305, the electronic payment information is received by payment authorization server 120-1. Payment authorization server 120-1 reads the account information data to, in accordance with an embodiment of the invention, determine whether the electronic payment transaction is a credit card, debit card or electronic check transaction (step 310). If payment authorization server 120-1 determines that the transaction is a credit card or debit card transaction, the transaction is considered for authorization and processed as such (step 315), in a manner that is well known and described below. If, however, the payment is determined to be an electronic check transaction, such payment is processed as described below with reference to steps 320-345.

Credit Card and Debit Card Transaction Process

Typically, when a credit card transaction is processed (step 315), data required to effectuate the transaction is inputted by merchant 110, a request for authorization to complete the transaction (based on the transaction data) is generated, an authorization is either granted or denied, and if authorization is granted, the process of transferring the necessary funds to effectuate the transaction is implemented. Such a transaction typically involves multiple parties including a consumer 100 (such as a credit card holder), a merchant 110, the merchant's financial institution 130, a bank card association 160, a data transaction provider 120 and the consumer's financial institution 150, the interrelationship of which are illustrated in FIG. 1.

The credit card holder is a consumer 100 that purchases (or requests a refund for) goods or services from merchant 110 using a credit card issued by the consumer's financial institution 150. Merchant 110 is a person or entity that sells goods or services and is able to accept and process electronic payments, such as credit cards, to complete the sale (or a refund).

Merchant financial institution 130 is an entity associated with at least one merchant 110 and effectuates payment to such merchant(s) 110 upon authorization of an electronic payment transaction (e.g., credit card transaction), and charges merchant(s) 110 a fee for handling each transaction. Consumer financial institution 150 is an entity that issues credit cards to approved consumers 100, receives and pays for transactions from bank card associations 160 and sends bills to consumer 100 and collects payment from consumers 100.

Bank card associations 160 are credit card payment service associations (such as Visa and MasterCard) that are made up of member financial institutions. Bank card associations 160, among other things, set and enforce rules governing their credit cards and conduct clearing and settlement processing. In addition, bank card associations 160 maintain national and international networks through which data funds are moved between consumers 100, merchants 110, merchant financial institutions 130 and consumer financial institutions 150.

Thus, suppose consumer 100 makes a typical $50.00 purchase from merchant 110 using a credit card that was issued by consumer financial institution 150. Upon inputting the transaction data (e.g., consumer's credit card number and expiration date, merchant's identification, the sale price, etc.), merchant processing unit 112 requests authorization from payment authorization server 120-1, associated bank card association processing unit 162 and ultimately consumer financial institution processing unit 152. The request for authorization is transmitted from merchant processing unit 112 to consumer financial institution processing unit 152 through the data transaction provider's payment authorization server 120-1 and the bank card association's processing unit 162. The resulting authorization (or rejection) is then issued by consumer financial institution processing unit 152 and transmitted back to merchant processing unit 112 through the bank card association processing unit 162 and data transaction provider's payment authorization server 120-1.

A debit card transaction by consumer 100 is processed in a similar fashion as described above, except that the funds are drawn from the consumer's banking account as opposed to the consumer's credit card account.

Electronic Check Transaction Process

Returning to step 310 of FIG. 3, if payment authorization server 120-1 determines, based upon the account data associated with the received electronic payment data, that an electronic check payment transaction has been initiated, the electronic payment data is formatted for authorization and processing (step 320) to effectuate the transaction. In an embodiment of the invention, such formatting comprises adapting the routing number and account number derived from the consumer's check in a manner such that this data can be processed by CPU 210-1 of payment authorization server 120-1.

At step 325, CPU 210-1 determines whether payment by electronic check is authorized—i.e., whether qualification of the transaction is positive. In accordance with an embodiment of the invention, qualification is positive when CPU 210-1 identifies a positive payment history associated with the consumer's checking account and the account contains a balance that is greater than the purchase price of the transaction; conversely, authorization is negative if the account balance is less than the purchase price and/or the there is a derogatory history associated with the checking account. In accordance with an alternate embodiment of the invention, if only one of these criteria is met—i.e., positive payment history or sufficient funds in the consumer's account—a positive qualification determination is made.

If the electronic check payment transaction generates a negative authorization response, such form of payment is denied (step 330) and payment authorization server 120-1 sends a message via communication port 240-1 to merchant processing unit 112 indicating that the electronic payment transaction has been aborted and that another form of payment should be requested of consumer 100 (step 330). If, however, the electronic check payment transaction generates a positive authorization response, payment authorization server 120-1 sends a message to merchant processing unit 112 via communication port 240-1 that the transaction has been authorized and that merchant 110 should request consumer confirmation (step 335).

At this point, a register receipt is generated for customer signature. With an electronic check payment transaction, merchant 110 may request, in accordance with an embodiment of the invention, that consumer 100 void the check which was used to initiate the electronic check payment transaction, sign the voided check and then provide merchant 110 with the check. It should be noted that this is only one protocol that may be used to effectuate an electronic check payment transaction and that other protocols may be used to perfect such a transaction.

Payment authorization server 120-1 awaits confirmation from merchant processing unit 112 that appropriate consumer confirmation (e.g., consumer signature) has been received (step 340). If consumer confirmation is not received, the electronic payment is denied (step 330) and payment authorization server 120-1 sends a message to merchant processing unit 112, via communication port 240-1, that the electronic payment transaction has been aborted. If, however, payment authorization server 120-1 receives consumer confirmation, merchant 110 is provided with transaction approval, receives a transaction authorization code and the payment is processed by provider 120 (step 345). At this point, the sales transaction—at the point of sale—is complete.

Settling and Reporting Electronic Payment Transactions

After the sales transaction, at the point of sale, is complete, system 100 executes settlement (including funding) and reporting of the electronic payment transactions. FIG. 4 is a flowchart illustrating the process of settling and reporting electronic payment transactions in accordance with an embodiment of the invention. It should be noted that, in accordance with an embodiment of the invention, merchants receive funding and reports respecting such transactions on a periodic basis—e.g., daily, semi-daily, weekly, etc. In any event, the process of settling a transaction is typically initiated at any time after electronic payment transaction is authorized by data transaction provider 120 and confirmed by consumer 100. Funding refers to the payment to a merchant 110 by data transaction provider 120 for one or more electronic payment transactions that have transpired. Settlement is the request for transfer of funds from one or more consumer financial institutions 150 relating to the payments/credits authorized by consumers 100 and the confirmation that funds are being transferred by merchant financial institution 130 to data transaction provider 120.

After an electronic payment by consumer 100 has been effectuated, deposit data is transmitted to and received by settlement server 120-2 (step 405) of data transaction provider 120, via communication port 240-2, and the data is stored in settlement/reporting database 256 (step 410) for subsequent effectuation of the settlement and reporting functions. Deposit data may include data relating to the method of payment, consumer account information, merchant identification information, consumer identification information, date of the transaction, time of the transaction and the transaction amount.

The settlement process includes the request for transfer of funds from one or more consumer financial institutions 150 relating to the payments/credits authorized by consumers 100 and the confirmation that funds are being transferred by merchant financial institution 130 to data transaction provider 120.

At steps 415 and 420, deposit data is extracted and formatted, respectively, by settlement server 120-2 for submitting a request for payment on behalf of merchant financial institution 130. The data extraction process handles the selection of the required deposit data for effectuating such a request. In certain electronic payment transactions types (for example, credit card and debit card transactions), the data as extracted may be in a format such that it can be readily submitted by settlement processor 120-2 to merchant financial institution processing unit 132. Thus, for example, these devices may be configured to read, for example, the 16-digit account number typically associated with a credit card and/or debit card account for settling the electronic payment transaction associated thereto.

In other instances, the deposit data requires formatting before such data can be processed. For example, in accordance with an embodiment of the invention, the routing and account information read from an electronic check may need to be formatted by CPU 210-2 of settlement server 120-2 in order to enable merchant financial institution processing unit 132 to read such information.

Once the data has been formatted (if required), the funds are sought by data transaction provider 120 (step 425). If, for example, the transaction that is being settled relates to an electronic check, then funds from one or more consumer financial institutions 150 for the payments/credits authorized by consumers 100 is sought by settlement/reconciliation server 120-2 of data transaction provider 120.

Identification of the appropriate financial institution codes for initiating and effectuating the settlement process is made by accessing financial institution database 254 for each electronic transaction that has transpired. Thus, server 120-2 accesses the data of a given electronic payment transaction (from electronic payment transaction database 252) to identify the merchant financial institution 130 that is involved in the transaction, and accesses financial information database 254 to identify the appropriate routing codes to establish communication with merchant financial institution 130 and to request that payment be made for settlement of the transaction. The funding amount sought on behalf of merchant 110 for such transaction is stored in settlement/reporting database 256.

For settlement of transactions involving, for example, an electronic check, settlement/reconciliation server 120-2 then forwards the request to processing unit 142 of automated clearing house 140. Automated clearing house 140 is an electronic network which transfers and clears funds relating to, in this example, electronic checking transactions between merchants 110 and consumers 100. Automated clearing house processing unit 142 then forwards the electronic check data to the consumer financial institution 150 on which the electronic check was drawn. Upon receiving the request for funds from automated clearing house 140, consumer financial institution processing unit 132 forwards the funds to data transaction provider 120 via automated clearing house 140.

A similar procedure is executed for credit card and debit card transactions. However, instead of utilizing automated clearing house 140 to receive funds from merchant financial institution processing unit 132, data transaction provider 120 interacts with bank card association 160 respecting such funding.

As described above, bank card associations 160, among other things, set and enforce rules governing their credit cards and conduct clearing and settlement processing. In addition, bank card associations 160 maintain national and international networks through which data funds are moved between consumers 100, merchants 110, merchant financial institution 130 and consumer financial institution 150.

Part of the settlement process respecting electronic payment transactions includes providing funds to merchant financial institution 130 for a transaction or a group of transactions (also called a “batch”) that has transpired during a given period of time. Thus, settlement/reconciliation server 120-2 is configured to receive information from settlement/reporting database 256 regarding the frequency and a cut-off time for which data transaction provider determines the funding amount and transfers funds to merchant 110. For example, in one aspect of the invention, electronic payment transactions that transpired up to a given period of time may be considered for funding, such that authorized funding is then transferred to merchant 110 within two days after the predetermined period of time. The cut-off time may be shorter (e.g., one day) or longer (e.g., a week). Thus, in accordance with an embodiment of the invention, processor 120-2 receives information that enables it to determine the appropriate cut-off time for a given merchant (step 430).

Next, in accordance with an embodiment of the invention, settlement/reconciliation server 120-2 categorizes the transpired electronic payment transactions for which merchant 110 has yet to receive funding (step 435). The transactions are categorized, for instance, by payment type. Thus, such payments may be categorized as credit card payments, electronic check payments and debit card payments. In so doing, settlement/reconciliation server 120-2 is configured to determine the transactions, for each transaction type, prior to the predetermined cut-off time, that are to be considered for funding (step 440).

Next, at step 445, settlement/reconciliation processor 120-2 determines the funding amount that is to be transferred by data transaction provider 120 to merchant 110. The amount of funding provided to merchant 110 typically equals the aggregate transaction amounts for settled transactions involving a given merchant that transpired during a the given period of time, less transaction processing fees imposed by, for example, data transaction provider 120. One such fee is called “interchange.” In an embodiment of the invention, such fee is charged by data transaction provider 120 for each transaction that it processes, settles and/or funds. The fee may be based on a per transaction basis regardless of transaction type, or may be on a transaction by transaction basis wherein the fee varies based upon the transaction type that was processed. Once the funds for a given transaction or batch of transactions has been received by merchant financial institution 130 (from data transaction provider 120) and paid by consumer financial institution 150 (to data transaction provider 120), and associated fees have been collected by data transaction provider 120, the settlement function of such transaction or batch is complete.

The funding amount to be transferred to merchants 110 may be determined in an alternate manner, in accordance with an aspect of the invention. It should be noted that the amount of time for data transaction processor 120 to settle different types of electronic payment transactions typically varies by transaction type. For example, a typical credit card transaction is settled in approximately 1 to 2 business days, whereas a typical electronic checking transaction settles in approximately 4 to 5 business days. In accordance with an embodiment of the invention, settlement/reconciliation server 120-2 can be configured to provide transaction funding or aggregate transaction funding to merchant financial institution 130, regardless of whether payment confirmation by consumer financial institution 150 to, for example, data transaction provider 120 has been. Thus, in such an embodiment, an entity such as data transaction provider 120 can provide payment to merchant 110 for one or more transactions in which data transaction provider 120 has yet to receive payment confirmation from consumer financial institution 150. Accordingly, although funding between data transaction provider 120 and merchant 110 for a group of transactions is complete when the funds are transferred between data transaction processor 120 and merchant financial institution 130, the settlement functionality may nevertheless be in progress until data transaction provider 120 has confirmed that it is to receive payment from merchant financial institution 130.

In accordance with an alternate embodiment of the invention, settlement/reconciliation server 120-2 is configured to determine the funding amount to be transferred to merchant 110 based upon the types of transactions that are to be settled prior to the predetermined cut-off time. For example, suppose the cut-off time for providing funding to a merchant is within two days after a period of time respecting a batch of transpired transactions. Settlement/reconciliation processor 120-2 is configured, in an aspect of the invention, to provide funding to merchant 110 for only those transactions that have settled within the cut-off time.

In another aspect of the invention, funding may depend on electronic payment transaction type. For example, settlement/reconciliation processor 120-2 may be configured such that funds respecting electronic payment transactions that have transpired within a certain prior to the cut-off time, but that are not scheduled to settle until after the cut-off time, are funded to merchant 110—even though such transactions have not settled. Such funding (before settlement) is called “pre-funding.” In such an embodiment, processor 120-2 may nevertheless be configured such that electronic payments for other transaction types—e.g., electronic check payments that are scheduled to settle prior to the cut-off time—are only funded if such payments are settled. Such a scenario enables partial pre-funding—i.e., pre-funding for only designated transaction types. It should be noted that processor 120-2 may be configured to determine, on a merchant-by-merchant basis, whether all transactions types (and thus all transactions) may be pre-funded, whether no transactions may be pre-funded, or whether pre-funding is authorized based upon transaction type.

Once processor 120-2 determines the funding amount to be transferred to merchant 110, such funds are transferred to merchant 110 prior to the designated cut-off time.

In addition to settling electronic payment transactions, data transaction provider 120 also generates a merchant report (step 465). Such report lists for merchant 110 each of the electronic payment transactions that was processed and/or funded on behalf of merchant 110 for a predetermined period of time—e.g., a given day, a predetermined number of days, week, etc. In accordance with an embodiment of the invention, the report includes transaction data (such as the date and time of the transaction, consumer identification, the transaction price and transaction type (e.g., purchase or refund)) for each credit card, debit card and electronic check payment (or refund) that was funded during that period. The report may also detail those transactions that have been processed but are awaiting finding and/or settlement. These reports may be generated electronically or in hard copy for submission to merchant 110 and storage by data transaction provider 120. In accordance with an embodiment of the invention, data stored in settlement/reporting database 256 includes information, on a merchant-to-merchant basis, relating to the frequency of generating merchant reports and the format (electronic, hard copy, etc.).

The foregoing merely illustrates the principles of the invention. It will thus be appreciated that those skilled in the art will be able to devise numerous other arrangements which embody the principles of the invention and are thus within its spirit and scope. For example, system 100 illustrates one consumer 100, merchant 110, data transaction provider 120, merchant financial institution 130, automated clearing house 140, consumer financial institution 150 and bank card association 160. It should be appreciated that such a structure is for simplicity purposes and that the system and methods described herein can support multiple consumers 100, merchants 110, data transaction providers 120, merchant financial institutions 130, automated clearing houses 140, consumer financial institutions 150 and bank card associations 160.

In addition, the electronic payment transactions described herein relate to credit card, debit card and electronic checking transactions. The system and method described herein can be modified to process, fund and report other types of electronic payment transactions, including transactions involving stored value cards, loyalty points redemptions, electronic benefits transfers.

1. A method for processing financial transactions, comprising:
receiving information relating to a plurality of electronic payment transactions;
categorizing each of said electronic payment transactions by one of a plurality of payment types; and
determining a funding amount to be paid to a merchant, for each of said payment types, wherein the funding amount relates to a transaction amount, wherein the transaction amount is based upon at least one of the plurality of electronic payment transactions.

2. The method of claim 1, wherein said one or more categories of payment types comprise at least one of the following: check payment, debit card payment credit card payment, stored value card payment, loyalty points redemptions, and electronic benefits transfers.

3. The method of claim 1, wherein the funding amount is further based upon an processing amount relating to one or more transaction processing fees.

4. The method of claim 1, further comprising:
generating a report identifying the funding provided to the merchant.

5. The method of claim 4, wherein the report identifies the electronic payment transactions that transpired prior to said defined period of time.

6. The method of claim 4, wherein the report is displayed electronically.

7. A system for processing financial transactions, comprising:
an interface for receiving information relating to a plurality of electronic payment transactions;
a memory device for categorizing each of said electronic payment transactions by one of a plurality of payment types; and
a processor for determining a funding amount to be paid to a merchant, for each of said payment types, wherein the funding amount relates to a transaction amount, wherein the transaction amount is based upon at least one of the plurality of electronic payment transactions.

8. The system of claim 7, wherein said one or more categories of payment types comprise at least one of the following: check payment, debit card payment credit card payment, stored value card payment, loyalty points redemptions, and electronic benefits transfers.

9. The system of claim 7, wherein the processor further determines the funding amount based upon a processing amount relating to one or more transaction processing fees.

10. The system of claim 7, further comprising:
an output device for generating a report identifying the funding provided to the merchant.

11. The system of claim 10, wherein the report identifies the electronic payment transactions that transpired prior to said defined period of time.

12. The system of claim 10, wherein the report is displayed electronically.

13. A method for processing financial transactions involving a merchant and consumers, comprising:
receiving information relating to a plurality of electronic payment transactions;
categorizing each of said electronic payment transactions by one of a plurality of payment types;
identifying a cut-off time for providing to a merchant funding relating to said electronic payment transactions;
identifying one or more categories of electronic payment transactions for which funds are to be transferred from a consumer account prior to the cut-off time, and one or more categories of electronic payment transactions for which funds may be transferred from an account associated with a consumer after the cut-off time;
receiving confirmation respecting the transfer of funds for at least one of electronic payment transactions of the type to be transferred from a consumer account prior to the cut-off time; and
providing funding to merchant prior to cut-off time, wherein the amount of said funding relates to the amount of funds for at least one of the electronic payment transactions for which said transfer confirmation is received and the amount of funds respecting the electronic payment transactions that may be transferred from a consumer account after the cut-off time.

14. The method of claim 13, wherein said one or more categories of payment types comprise at least one of the following: check payment, debit card payment credit card payment, stored value card payment, loyalty points redemptions, and electronic benefits transfers.

15. The method of claim 13, wherein the amount of funding equals the amount of funds for at least one of the electronic payment transactions for which said transfer confirmation is received and the amount of funds respecting the electronic payment transactions that may be transferred from a consumer account after the cut-off time.

16. The method of claim 13, wherein the amount of funding equals the amount of funds for at least one of the electronic payment transactions for which said transfer confirmation is received and the amount of funds respecting the electronic payment transactions that may be transferred from a consumer account after the cut-off time, less an amount relating to one or more transaction fees.

17. The method of claim 13, wherein the received information relates to electronic payment transactions that transpired prior to a defined period of time and the cut-off time is within a predetermined amount of time after said defined period of time.

18. The method of claim 17, further comprising:
generating a report identifying the funding provided to the merchant.

19. The method of claim 18, wherein the report identifies the electronic payment transactions that transpired prior to said defined period of time.

20. The method of claim 18, wherein the report is displayed electronically.

21. A system for processing financial transactions involving a merchant and consumers, comprising:
an interface for receiving information relating to a plurality of electronic payment transactions; and
a memory device for categorizing each of said electronic payment transactions by one of a plurality of payment types; and
a processor:
for identifying a cut-off time for providing to a merchant funding relating to said electronic payment transactions,
for identifying one or more categories of electronic payment transactions for which funds are to be transferred from a consumer account prior to the cut-off time, and one or more categories of electronic payment transactions for which funds may be transferred from an account associated with a consumer after the cut-off time,
for receiving confirmation respecting the transfer of funds for at least one of electronic payment transactions of the type wherein funds are to be transferred from a consumer account prior to the cut-off time, and
for providing funding to merchant prior to cut-off time, wherein the amount of said funding relates to the amount of funds for at least one of the electronic payment transactions for which said transfer confirmation is received and the amount of funds respecting the electronic payment transactions that may be transferred from a consumer account after the cut-off time.

22. The system of claim 21, wherein said one or more categories of payment types comprise at least one of the following: check payment, debit card payment credit card payment, stored value card payment, loyalty points redemptions, and electronic benefits transfers.

23. The system of claim 21, wherein the processor calculates the amount of funding by totaling the amount of funds for at least one of the electronic payment transactions for which said transfer confirmation is received and the amount of funds respecting the electronic payment transactions that may be transferred from a consumer account after the cut-off time.

24. The system of claim 21, wherein the processor calculates the amount of funding by totaling the amount of funds for at least one of the electronic payment transactions for which said transfer confirmation is received and the amount of funds respecting the electronic payment transactions that may be transferred from a consumer account after the cut-off time, and decrementing an amount relating to one or more transaction fees.

25. The system of claim 21, wherein the received information relates to electronic payment transactions that transpired prior to a defined period of time and the cut-off time is within a predetermined amount of time after said defined period of time.

26. The system of claim 25, further comprising:
an output device for generating a report identifying the funding provided to the merchant.

27. The system of claim 26, wherein the report includes the electronic payment transactions that transpired prior to said defined period of time.

28. The system of claim 26, wherein the output device is configured for displaying the report electronically.
